(19) United States
(12) Patent Application Publication
(10) Pub. No.: US 2026/0327520 A1
(43) Pub. Date: Oct. 22, 2026

(54) STABILIZED CLEANING COMPOSITIONS COMPRISING EDDS AND ENZYMES AND THEIR USE

(71) Applicant: BASF SE, Ludwigshafen am Rhein (DE)

(72) Inventors: Michael CAPRACOTTA, Wyandotte, MI (US); Peter A. MILLER, Wyandotte, MI (US); Marta REINOSO GARCIA, Ludwigshafen am Rhein (DE); Claudia ESPER, Ludwigshafen am Rhein (DE)

(21) Appl. No.: 19/485,345

(22) PCT Filed: May 29, 2024
(86) PCT No.: PCT/EP2024/064794

§ 371 Date: Nov. 18, 2025

(30) Foreign Application Priority Data
Jun. 13, 2023 (EP) 23178977.7

(51) Int. Cl. C11D 3/33; C11D 1/22; C11D 1/29; C11D 1/83; C11D 3/04; C11D 3/386

(52) U.S. Cl. CPC C11D 3/33; C11D 1/22; C11D 1/29; C11D 3/04; C11D 3/38618; C11D 3/38663; C11D 1/83; C11D 2111/12

(57) ABSTRACT

Disclosed herein are a liquid cleaning composition including (i) ethylenediamine-N,N′-disuccinic acid (EDDS), (ii) at least one enzyme selected from the group consisting of amylase and protease, (iii) at least one anionic surfactant, (iv) calcium (Ca²⁺) and (v) water to enhance the long-term stability of the enzyme(s), a process of producing same, and methods of using the same, for example in laundry or dishwashing.

This invention deals with specific cleaning compositions (in this present invention abbreviated as “inventive composition” or “composition of the invention” whenever the inventive compositions are meant) comprising ethylenediamine-N,N′-disuccinic acid (EDDS) (abbreviated as “inventive component I”) and a protease and/or amylase (abbreviated as “inventive component II”), their manufacture, their uses, particularly as laundry detergent compositions.

Detergent and home care product formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, by-products of incomplete hydrocarbon combustion, and organic soils like sebum and starch-based soils. These challenging demands become even more challenging in view of the emerging trends to improve the “footprint” of any cleaning product, be it in terms of its origin like being from natural or renewable resources, or compared to previous products, its production in terms of production efficiency and thus reduced usage of energy, its efficiency in usage such as reduced amounts for the same performance or higher performance at the same amount levels used, its persistence in the natural environment after its usage, especially its biodegradation, since recycling is technically very challenging and therewith economically not attractive.

As a result of these trends, there is a strong need for new biodegradable cleaning compositions that provide both excellent primary (i.e., soil removal) and secondary (i.e., whiteness maintenance) cleaning benefits for both hydrophobic and hydrophilic stains, and an improved biodegradability. One step into the direction of sustainable cleaning compositions is the increased use of enzymes. However, the conditions found in cleaning compositions are far from being optimal for long-term storage of enzymes. Cleaning compositions contain surfactants that can interfere with enzyme integrity. The same holds true for polymeric cleaning components. In addition, builders may compete with enzymes for alkaline earth metals, such as calcium or magnesium cations which are important co-factors for enzymes, like amylases and proteases. Thus, many standard cleaning components when applied in their active concentrations pose a threat on enzymes and their long-term stability. To overcome this problem, cleaning compositions may contain enzyme stabilizing components, such as boric acid, boronic acid and derivatives thereof. However, boric acid is registered under the REACH Regulation and is suspected of damaging fertility and the unborn child reducing the acceptance of authorities and customers for boron-containing enzyme stabilizing components. Hence, there is a need to find improved enzyme-containing cleaning compositions with high performance profile, increased consumer safety and an improved biodegradation behavior.

In the following, a summary of the current knowledge and most relevant publications in the field of the present invention, the combined use of established builders or EDDS with enzymes is given. One class of frequently used builder components in cleaning compositions are polyphosphonates. These synthetic compounds differ from natural phosphonates, such as 2-aminoethylphosphonic acid, because they are larger and anionic and often occur in complexes with metals. Biodegradation tests on 1-hydroxy ethylidene-1,1-diphosphonic acid (HEDP) and nitrilotris-methylenephosphonic acid (NTMP) showed no indication for any degradation. Further, an investigation of 1-hydroxy ethylidene-1,1-diphosphonic acid (HEDP), nitrilotris-methylenephosphonic acid (NTMP), ethylenediamine tetra(methylene phosphonic acid) (EDTMP) and diethylenetriamine penta(methylene phosphonic acid) (DTPMP) in standard biodegradation tests also failed to identify any biodegradation. Therefore, with respect to biodegradation the use of polyphosphonates in cleaning compositions is not desired.

Another well-established class of builder compounds used in home care products are aminopolycarboxylate chelating agents. This class, like the polyphosphonates, comprises a huge variety of compounds, such as ethylenediaminetetraacetic acid (EDTA), nitrilotriacetic acid (NTA), diethylenetriaminepentaacetic acid (DTPA), and tetranatrium-N,N-bis(carboxylatomethyl)-L-glutamat (GLDA). EDTA is the most widely used chelating agent in the world. The widespread use of EDTA and its slow removal under many environmental conditions has led to its standing as the anthropogenic compound at the highest concentration in many European surface waters. For this reason, manufacturers are looking for alternative chelators with higher biodegradability. NTA on the other hand has a better biodegradability than EDTA but can cause eye, skin and respiratory tract irritation and kidney and bladder damage. Additionally, NTA is considered to have potential to cause cancer in humans. Moreover, the present application provides experimental evidence that DTPA and GLDA impair the long-term stability of proteases and/or amylases.

The use of citrate as a builder is known since the early 1970s, as described, for example, in U.S. Pat. No. 4,028,262 A. However, also this compound negatively impairs the long-term stability of amylases, as experimentally demonstrated by the present inventors and therefore does not represent an ideal solution for future cleaning formulations comprising increased amounts of enzymes.

WO9606908 A discloses the use of EDDS in detergents together with enzymes, such as proteases and amylases. However, the detergent formulations comprising EDDS and enzymes are not specifically prepared to establish long-term enzyme stability. To achieve this long-term stability WO9606908 A describes enzyme stabilizers, preferably boric acid and boronic acid-based compounds which have the above-described negative effects of being registered under the REACH Regulation and being under suspicion of damaging fertility and the unborn child.

Thus, there is a need in the art to find cleaning compositions that comprise a combination of surfactants, builders and enzyme wherein said cleaning composition is free of boric or boronic acid, has high biodegradability and provides long-term enzymatic stability and customer safety.

The present inventors surprisingly found that the combination of ethylenediamine-N,N′-disuccinic acid (EDDS) with a protease or amylase within a specific cleaning composition formulation (e.g. specific anionic surfactant and calcium concentration, pH-value and viscosity) results in cleaning compositions that demonstrate increased consumer safety, have high biodegradability and provide long-term enzymatic stability. Experimental comparison with other chelating agents, such as diethylenetriamine penta(methylene phosphonic acid) (DTPMP), 1-hydroxy ethylidene-1,1-diphosphonic acid (HEDP), citrate, diethylenetriaminepentaacetic acid (DTPA), and tetranatrium-N,N-bis(carboxylatomethyl)-L-glutamat (GLDA), demonstrates that EDDS is the only builder that provides biodegradability and protease/amylase stability and can therefore be used in a cleaning composition without strong enzyme stabilizers, such as boric or boronic acid.

Thus, the object of the present invention is to provide novel liquid cleaning compositions comprising (i) ethylenediamine-N,N′-disuccinic acid (EDDS) in an amount ranging from 0.0005% to 20% by weight of the composition; (ii) at least one enzyme in an amount ranging from 0.000001% to 5% by weight of the composition, wherein the at least one enzyme is selected from the group consisting of amylase and protease; (iii) at least one anionic surfactant in an amount ranging from 0.1% to 50% by weight of the composition; (iv) calcium (Ca²⁺) in an amount ranging from 0.000001% to 5% by weight of the composition; and (v) water, wherein the cleaning composition has a viscosity ranging from 20 to 10000 mPa*s measured with the relevant method in accordance with the description and a pH-value ranging between 4 and 14.

The liquid cleaning compositions of the invention may further comprise at least one element of the group consisting of nonionic surfactants, amphoteric surfactants, co-builders, alcohols, biocides, thickeners, water soluble polymers, clay soil removal/anti-redeposition agents, polymeric soil release agents, bleaching agents, bleach activators, brighteners, malodor control agents, pigments, dyes, opacifiers, hueing agents, dye transfer inhibiting agents, suds suppressors (antifoams), anti-corrosion agents, softeners and perfumes.

In another aspect, the liquid cleaning composition of the invention is used for cleaning of fabrics.

Further, a cleaning method comprising contacting the inventive liquid cleaning composition and fabrics is also part of the invention.

In addition, the invention is directed to a method of manufacturing the inventive liquid cleaning composition comprising bringing in contact the components (i) to (v) of the liquid cleaning composition as described above and mixing them.

Thus, subjects of the present invention are the following Embodiments 1 to 15 as defined and further explained with further embodiments hereinafter and further exemplified in the experimental section:

### EMBODIMENT 1

A liquid cleaning composition comprising (i) ethylenediamine-N,N′-disuccinic acid (EDDS) in an amount ranging from 0.0005% to 20% by weight of the composition; (ii) at least one enzyme in an amount ranging from 0.000001% to 5% by weight of the composition, wherein the at least one enzyme is selected from the group consisting of amylase and protease; (iii) at least one anionic surfactant in an amount ranging from 0.1% to 50% by weight of the composition; (iv) calcium (Ca²⁺) in an amount ranging from 0.000001% to 5% by weight of the composition; and (v) water, wherein the cleaning composition has a viscosity ranging from 20 to 10000 mPa*s measured with the relevant method in accordance with the description and a pH-value ranging between 4 and 14.

“Liquid”, as used herein, means that a continuous phase or predominant part of the composition is liquid and that the composition is flowable at 20° C. (i.e., suspended solids may be included). The term “liquid” also includes gels. “Gel”, as used herein, means a shear thinning, lamellar gel, with a pouring viscosity in the range of from 100 to 5000 mPa*s (milli Pascal seconds), more preferably less than 3000 mPa*s, most preferably less than 1500 mPa*s. The gel can be a thick liquid. Nevertheless, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick at low shear condition (e.g., at rest) and thin at high flow rate condition. Thus, the cleaning composition includes detergent or automatic dish wash (ADW) gels.

The term “cleaning composition” or “cleaning agent”, as interchangeably used herein, refers to all compositions intended to be used in connection with and for increasing the effectiveness of cleaning activities. The term cleaning agent includes, but is not limited to, hard surface cleaning compositions (kitchen cleaning compositions, bathroom cleaning composition, floor cleaning compositions, general household cleaning composition, glass cleaning compositions), detergents, dish washing composition, food cleaning compositions, cloth and fibre cleaning compositions, disinfectants, and the like. The term “cleaning”, as used herein, refers to those activities which involve the removal of undesirable residues from surfaces and particularly includes activities such as chemical, mechanical, and thermal cleaning activities as well as combinations thereof. Chemical cleaning activities include for example the use of solvents for removing the residues from the surface, potentially further involving the use surface active substances to increase the compatibility between residue and solvent. Chemical cleaning activities further include chemical alteration of the residues to improve the ease of removal of the residue. The inventive cleaning compositions include at least five components, namely (i) EDDS, (ii) a protease and/or amylase, (iii) at least one anionic surfactant, (iv) calcium cations (Ca²⁺) and (v) water.

An “enzyme”, as used herein, refers to any of numerous proteins produced in living cells that naturally accelerate or catalyze the metabolic processes of an organism. Enzymes act on substrates. The substrate binds to the enzyme at a location called the active site just before the reaction catalyzed by the enzyme takes place. Enzymes according to the present application include, but are not limited to, amylases or proteases, which are also called inventive compound II. However, the cleaning composition of the present invention may also contain further enzymes asides the amylase or protease which can be selected from the group comprising lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins or combinations thereof.

The term “at least one”, as used herein, includes but is not limited to 1, 2, 3, 4, 5, 6, 7, 8, 9 and more.

### EMBODIMENT 2

The liquid cleaning composition according to Embodiment 1, wherein ethylenediamine-N,N′-disuccinic acid (EDDS) is present in an amount ranging from 0.001% to 15%, preferably from to 0.01% to 10%, most preferably from 0.1% to 5% by weight of the composition.

EDDS has the structure of Formula (I):

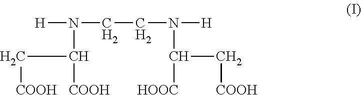 [SMILES: O=C(O)CC(NCCNC(CC(=O)O)C(=O)O)C(=O)O]

EDDS has two chirality centers. Thus, EDDS can appear in three different stereoisomeric forms, namely [R,R], [R,S]/[S,R], [S,S]. [S,S] EDDS is fully biodegradable, whereas meso-EDDS is at least partially biodegradable. The [S,S] stereoisomer is a derivative of the natural amino acid L-aspartic acid and this origin may be the reason for its good biodegradability. The [R,R] stereoisomer persists in the environment. Thus, in preferred embodiments of the invention EDDS is [S,S] EDDS or meso-EDDS, more preferably [S,S] EDDS.

EDDS is commercially available, for example, from Sigma-Aldrich (St. Louis, Missouri, USA). Alternatively, it can be prepared using maleic anhydride and ethylenediamine. The preferred biodegradable [S,S] isomer can be prepared by reacting L-aspartic acid with 1,2-dibromoethane. The EDDS may be in its salt form, i.e., wherein one or more of the four acidic hydrogens are replaced by a water-soluble cation M, such as sodium, potassium, ammonium, triethanolammonium, and the like.

In preferred embodiments, the lower limit of the EDDS concentration is 0.0005%, 0.005% or 0.05% by weight of the inventive composition. In other preferred embodiments, the upper limit of the EDDS concentration is 8%, 7% or 6% by weight of the inventive composition.

### EMBODIMENT 3

The liquid cleaning composition according to Embodiment 1 or 2, wherein the at least enzyme is present in an amount ranging from 0.00001% to 2%, preferably from to 0.0001% to 1%, most preferably from 0.001% to 0.5% by weight of the composition.

In preferred embodiments, the lower limit of the enzyme concentration is 0.00005% or 0.0005% by weight of the inventive composition. In other preferred embodiments, the upper limit of the enzyme concentration is 1.7%, 1.3% or 0.8% by weight of the inventive composition.

### EMBODIMENT 4

The liquid cleaning composition according to any one of Embodiments 1 to 3, wherein (a) the amylase is an alpha-amylase; and/or (b) the protease is a subtilisin protease.

“Amylases”, according to the invention, (alpha and/or beta) include those of bacterial or fungal origin (EC 3.2.1.1 and 3.2.1.2, respectively). The term also includes variants and mutants of naturally occurring amylases, so-called wild-type proteins. Preferably, amylases are selected from the group of alpha-amylases (EC 3.2.1.1). Chemically modified or protein engineered mutants are included. Amylases according to the invention have “amylolytic activity” or “amylase activity” involving (endo)hydrolysis of glucosidic linkages in polysaccharides. Alpha-amylase activity may be determined by assays for measurement of alpha-amylase activity which are known to those skilled in the art. Examples for assays measuring alpha-amylase activity are:

Alpha-amylase activity can be determined by a method employing Phadebas tablets as substrate (Phadebas Amylase Test, supplied by Magle Life Science). Starch is hydrolyzed by the alpha-amylase giving soluble blue fragments. The absorbance of the resulting blue solution, measured spectrophotometrically at 620 nm, is a function of the alpha-amylase activity. The measured absorbance is directly proportional to the specific activity (activity/mg of pure alpha-amylase protein) of the alpha-amylase in question under the given set of conditions.

Alpha-amylase activity can also be determined by a method employing the Ethyliden-4-nitrophenyl-alpha-D-maltoheptaosid (EPS). D-maltoheptaoside is a blocked oligosaccharide which can be cleaved by an endo-amylase. Following the cleavage, the alpha-glucosidase included in the kit to digest the substrate to liberate a free PNP molecule which has a yellow color and thus can be measured by visible spectophotometry at 405 nm. Kits containing EPS substrate and alpha-glucosidase is manufactured by Roche Costum Biotech (cat. No. 10880078103). The slope of the time dependent absorption-curve is directly proportional to the specific activity (activity per mg enzyme) of the alpha-amylase in question under the given set of conditions.

Amylolytic activity may be provided in units per gram enzyme. For example, 1 unit alpha-amylase may liberate 1.0 mg of maltose from starch in 3 min at pH 6.9 at 20° C.

Independent of the nature of the assay, the amylase variants used in the composition of the invention may have at least 40%, at least 60%, at least 70%, at least 80%, at least 90%, at least 100% or at least 110% of the amylase activity measured for the corresponding wild-type amylase.

Amylases may be from Bacillus licheniformis having SEQ ID NO:2 as described in WO 95/10603 and variants at least 95% thereto. Suitable variants are described in WO 95/10603 comprising one or more substitutions in the following positions: 15, 23, 105, 106, 124, 128, 133, 154, 156, 178, 179, 181, 188, 190, 197, 201, 202, 207, 208, 209, 211, 243, 264, 304, 305, 391, 408, and 444 which have amylolytic activity. Variants are described in WO 94/02597, WO 94/018314, WO 97/043424 and SEQ ID NO:4 of WO 99/019467.

Amylases further maybe from B. stearothermophilus having SEQ ID NO:6 as disclosed in WO 02/10355 or an amylase with optionally having a C-terminal truncation over the wildtype sequence. Suitable variants of SEQ ID NO:6 include those comprising a deletion in positions 179 and/or 181 and/or 182 and/or a substitution in position 193.

Amylases further may be from Bacillus sp.707 having SEQ ID NO:6 as disclosed in WO 99/19467 and variants at least 95% thereto. Preferred variants of SEQ NO: 6 are those having a substitution, a deletion or an insertion in one or more of the following positions: R181, G182, H183, G184, N195, I206, E212, E216 and K269.

Amylases further maybe from Bacillus halmapalus having SEQ ID NO:2 or SEQ ID NO:7 as described in WO 96/23872, also described herein as SP-722. Preferred variants are described in WO 97/3296, WO 99/194671 and WO 2013/001078.

Amylases further may be from Bacillus sp. DSM 12649 having SEQ ID NO:4 as disclosed in WO 00/22103 and variants at least 95% thereto.

Amylases further may be from Bacillus sp. A 7-7 (DSM 12368) having an amino acid sequence at least 95% identical to SEQ ID NO:2, in particular over the region of the amino acids 32 to 516 according to SEQ ID NO:2, as disclosed in WO 02/10356.

Amylases further may be from Bacillus strain TS-23 having SEQ ID NO:2 as disclosed in WO 2009/061380 and variants thereof.

Amylases further may be from Cytophaga sp. having SEQ ID NO:1 as disclosed in WO 2013/184577 and variants at least 95% thereto.

Amylases further may be from Bacillus megaterium DSM 90 having SEQ ID NO:1 as disclosed in WO 2010/104675 and variants at least 95% thereto.

Amylases further may be from Bacillus sp. comprising amino acids 1 to 485 of SEQ ID NO:2 as described in WO 00/60060 and variants at least 95% thereto.

Amylases further may be from Bacillus amyloliquefaciens or variants thereof, preferably selected from amylases according to SEQ ID NO: 3 as described in WO 2016/092009.

Amylases may have SEQ ID NO:12 as described in WO 2006/002643 or amylase variants thereof comprising the substitutions Y295F and M202LITV within said SEQ ID NO:12.

Amylases may have SEQ ID NO:6 as described in WO 2011/098531 or amylase variants comprising a substitution at one or more positions selected from the group consisting of 193 [G,A,S,T or M], 195 [F,W,Y,L,I or V], 197 [F,W,Y,L,I or V], 198 [Q or N], 200 [F,W,Y,L,I or V], 203 [F,W,Y,L,I or V], 206 [F,W,Y,N,L,I,V,H,Q,D or E], 210 [F,W,Y,L,I or V], 212 [F,W,Y,L,I or V], 213 [G,A,S,T or M] and 243 [F,W,Y,L,I or V] within said SEQ ID NO:6.

Amylases may have SEQ ID NO:1 as described in WO 2013/001078 or amylase variants comprising an alteration at two or more (several) positions corresponding to positions G304, W140, W189, D134, E260, F262, W284, W347, W439, W469, G476, and G477 within said SEQ ID NO:1.

Amylases may have SEQ ID NO:2 as described in WO 2013/001087 or amylase variants comprising a deletion of positions 181+182, or 182+183, or 183+184, within said SEQ ID NO:2, optionally comprising one or two or more modifications in any of positions corresponding to W140, W159, W167, Q169, W189, E194, N260, F262, W284, F289, G304, G305, R320, W347, W439, W469, G476 and G477 within said SEQ ID NO:2.

Amylases may be hybrid alpha-amylases from above mentioned amylases as for example as described in WO 2006/066594.

Hybrid amylases may be according to WO 2014/183920 with A and B domains having at least 90% identity to SEQ ID NO:2 of WO 2014/183920 and a C domain having at least 90% identity to SEQ ID NO:6 of WO 2014/183920, wherein the hybrid amylase has amylolytic activity; preferably the hybrid alpha-amylase is at least 95% identical to SEQ ID NO: 23 of WO 2014/183920 and having amylolytic activity.

Hybrid amylases may be according to WO 2014/183921 with A and B domains having at least 75% identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% identity to SEQ ID NO: 6 of WO 2014/183921, wherein the hybrid amylase has amylolytic activity; preferably, the hybrid alpha-amylase is at least 95% identical to SEQ ID NO: 30 as disclosed in WO 2014/183921 and having amylolytic activity;

Hybrid amylases may be according to WO 2021/032881 comprising an A and B domain originating from the alpha amylase originating from Bacillus sp. A 7-7 (DSM 12368) and a C domain originating from the alpha-amylase from Bacillus cereus; preferably, the A and B domain are at least 75% identical to the amino acid sequence of SEQ ID NO: 42 and a C domain is at least 75% identical to the amino acid sequence of SEQ ID NO: 44—both sequences as disclosed in WO 2021/032881; more preferably, the hybrid amylase is at least 80% identical to SEQ ID NO:54 as disclosed in WO 2021/032881.

Suitable amylases include also those, which are variants of the above-described amylases which have amylolytic activity. In one embodiment amylase variants include variants with at least 40 to 100% identity when compared to the full-length polypeptide sequence of the parent enzyme as disclosed above. In one embodiment amylase variants having amylolytic activity are at least 70%, at least 75%, at least 80%, at least 85%, at least 90%, at least 91%, at least 92%, at least 93%, at least 94%, at least 95%, at least 96%, at least 97%, at least 98% or at least 99% identical to the full-length polypeptide sequence of the parent (wild-type) enzyme as disclosed above.

In another embodiment, the invention relates to amylase variants comprising conservative mutations not pertaining the functional domain of the respective amylase. Amylase variants of this embodiment having amylolytic activity may be at least 70%, at least 75%, at least 80%, at least 85%, at least 90%, at least 91%, at least 92%, at least 93%, at least 94%, at least 95%, at least 96%, at least 97%, at least 98% or at least 99% similar to the full-length polypeptide sequence of the parent (wild-type) enzyme.

In one embodiment, amylase variants have amylolytic activity according to the present invention when said amylase variants exhibit increased amylolytic activity when compared to the parent (wild-type) amylase.

In one embodiment, amylase variants have amylolytic activity according to the present invention when said amylase variants exhibit at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or 100% of the amylolytic activity of the respective parent (wild-type) amylase.

In one embodiment, at least one amylase is selected from commercially available amylases which include but are not limited to products sold under the trade names Duramyl™, Termamyl™, Fungamyl™, Stainzyme™, Stainzyme Plus™, Natalase™, Liquozyme X and BAN™, Amplify™, Amplify Prime™ (from Novozymes A/S), and Rapidase™, Purastar™, Powerase™, Effectenz™ (M100 from DuPont), Preferenz™ (S1000, S110 and F1000; from DuPont), PrimaGreen™ (ALL; DuPont), Optisize™ (DuPont).

Enzymes having proteolytic activity are called “proteases” or “peptidases”. The term also includes variants and mutants of naturally occurring proteases, so-called wild-type proteins. Proteases are active proteins exerting “protease activity” or “proteolytic activity”. Proteolytic activity is related to the rate of degradation of protein by a protease or proteolytic enzyme in a defined course of time.

The methods for analyzing proteolytic activity are well-known in the literature (see e.g. Gupta et al. (2002), Appl. Microbiol. Biotechnol. 60: 381-395). Proteolytic activity may be determined by using Succinyl-Ala-Ala-Pro-Phe-p-nitroanilide (Suc-AAPF-pNA, short AAPF; see e.g. DelMar et al. (1979), Analytical Biochem 99, 316-320) as substrate. pNA is cleaved from the substrate molecule by proteolytic cleavage, resulting in release of yellow color of free pNA which can be quantified by measuring OD405.

Proteolytic activity may be provided in units per gram enzyme. For example, 1 U protease may correspond to the amount of protease which sets free 1 μmol folin-positive amino acids and peptides (as tyrosine) per minute at pH 8.0 and 37° C. (casein as substrate).

Independent of the nature of the assay, the protease variants used in the composition of the invention may have at least 40%, at least 60%, at least 70%, at least 80%, at least 90%, at least 100% or at least 110% of the amylase activity measured for the corresponding wild-type protease.

Proteases are members of class EC 3.4. Proteases include aminopeptidases (EC 3.4.11), dipeptidases (EC 3.4.13), dipeptidyl-peptidases and tripeptidyl-peptidases (EC 3.4.14), peptidyl-dipeptidases (EC 3.4.15), serine-type carboxypeptidases (EC 3.4.16), metallocarboxypeptidases (EC 3.4.17), cysteine-type carboxypeptidases (EC 3.4.18), omega peptidases (EC 3.4.19), serine endopeptidases (EC 3.4.21), cysteine endopeptidases (EC 3.4.22), aspartic endopeptidases (EC 3.4.23), metallo-endopeptidases (EC 3.4.24), threonine endopeptidases (EC 3.4.25), or endopeptidases of unknown catalytic mechanism (EC 3.4.99).

At least one protease may be selected from metallo endoproteases (EC 3.4.24). A metalloprotease may for example be a thermolysin from, e.g., family M4 or another metalloprotease such as those from M5, M7 or M8 families. A metalloprotease may especially be derived from Bacillus amyloliquefaciens described in WO 07/044993A2, from Bacillus, Brevibacillus, Thermoactinomyces, Geobacillus, Paenibacillus, Lysinibacillus or Streptomyces spp. described in WO 2014194032, WO 2014194054, and WO 2014194117, from Kribella alluminosa described in WO 2015193488, and from Streptomyces and Lysobacter described in WO 2016075078.

More preferably, at least one protease may be selected from serine proteases (EC 3.4.21). Serine proteases or serine peptidases are characterized by having a serine in the catalytically active site, which forms a covalent adduct with the substrate during the catalytic reaction. A serine protease may be selected from the group consisting of chymotrypsin (e.g., EC 3.4.21.1), elastase (e.g., EC 3.4.21.36), elastase (e.g., EC 3.4.21.37 or EC 3.4.21.71), granzyme (e.g., EC 3.4.21.78 or EC 3.4.21.79), kallikrein (e.g., EC 3.4.21.34, EC 3.4.21.35, EC 3.4.21.118, or EC 3.4.21.119,) plasmin (e.g., EC 3.4.21.7), trypsin (e.g., EC 3.4.21.4), thrombin (e.g., EC 3.4.21.5), and subtilisin. Subtilisin is also known as subtilopeptidase, e.g., EC 3.4.21.62, the latter hereinafter also being referred to as “subtilisin”.

The subtilisin related class of serine proteases shares a common amino acid sequence defining a catalytic triad which distinguishes them from the chymotrypsin related class of serine proteases. Subtilisins and chymotrypsin related serine proteases both have a catalytic triad comprising aspartate, histidine and serine.

In the subtilisin related proteases the relative order of these amino acids, reading from the amino to carboxy-terminus is aspartate-histidine-serine. In the chymotrypsin related proteases the relative order, however is histidine-aspartate-serine. Thus, subtilisin herein refers to a serine protease having the catalytic triad of subtilisin related proteases. Examples include the subtilisins as described in WO 89/06276 and EP 0283075, WO 89/06279, WO 89/09830, WO 89/09819, WO 91/06637 and WO 91/02792.

Parent proteases of the subtilisin type (EC 3.4.21.62) and variants may be bacterial proteases. Said bacterial protease may be a Gram-positive bacterial polypeptide such as a Bacillus, Clostridium, Enterococcus, Geobacillus, Lactobacillus, Lactococcus, Oceanobacillus, Staphylococcus, Streptococcus, or Streptomyces protease, or a Gram-negative bacterial polypeptide such as a Campylobacter, E. coli, Flavobacterium, Fusobacterium, Helicobacter, Ilyobacter, Neisseria, Pseudomonas, Salmonella, or Ureaplasma protease. A review of this family is provided, for example, in “Subtilases: Subtilisin-like Proteases” by R. Siezen, pages 75-95 in “Subtilisin enzymes”, edited by R. Bott and C. Betzel, New York, 1996.

In one aspect of the invention, the parent enzymes and variants may be a Bacillus alcalophilus, Bacillus amyloliquefaciens, Bacillus brevis, Bacillus circulans, Bacillus clausii, Bacillus coagulans, Bacillus firmus, Bacillus gibsonii, Bacillus lautus, Bacillus lentus, Bacillus licheniformis, Bacillus megaterium, Bacillus pumilus, Bacillus sphaericus, Bacillus stearothermophilus, Bacillus subtilis, or Bacillus thuringiensis protease.

For the purpose of the invention, at least one protease may be selected from the following: subtilisin from Bacillus amyloliquefaciens BPN′ (described by Vasantha et al. (1984) J. Bacteriol. Volume 159, p. 811-819 and J A Wells et al. (1983) in Nucleic Acids Research, Volume 11, p. 7911-7925); subtilisin from Bacillus licheniformis (subtilisin Carlsberg; disclosed in E L Smith et al. (1968) in J. Biol Chem, Volume 243, pp. 2184-2191, and Jacobs et al. (1985) in Nucl. Acids Res, Vol 13, p. 8913-8926); subtilisin PB92 (original sequence of the alkaline protease PB92 is described in EP 283075 A2); subtilisin 147 and/or 309 (Esperase®, Savinase®, respectively) as disclosed in WO 89/06279; subtilisin from Bacillus lentus as disclosed in WO 91/02792, such as from Bacillus lentus DSM 5483 or the variants of Bacillus lentus DSM 5483 as described in WO 95/23221; subtilisin from Bacillus alcalophilus (DSM 11233) disclosed in DE 10064983; subtilisin from Bacillus gibsonii (DSM 14391) as disclosed in WO 2003/054184; subtilisin from Bacillus sp. (DSM 14390) disclosed in WO 2003/056017; subtilisin from Bacillus sp. (DSM 14392) disclosed in WO 2003/055974; subtilisin from Bacillus gibsonii (DSM 14393) disclosed in WO 2003/054184; subtilisin having SEQ ID NO: 4 as described in WO 2005/063974; subtilisin having SEQ ID NO: 4 as described in WO 2005/103244; subtilisin having SEQ ID NO: 7 as described in WO 2005/103244; and subtilisin having SEQ ID NO: 2 as described in application DE 102005028295.4.

Suitable proteases include also those, which are variants of the above-described proteases which have proteolytic activity. In one embodiment protease variants include variants with at least 40 to 100% identity to the full-length polypeptide sequence of the parent enzyme as disclosed above. In one embodiment protease variants having proteolytic activity are at least 70%, at least 75%, at least 80%, at least 85%, at least 90%, at least 91%, at least 92%, at least 93%, at least 94%, at least 95%, at least 96%, at least 97%, at least 98% or at least 99% identical to the full-length polypeptide sequence of the parent (wild-type) enzyme as disclosed above.

In another embodiment, the invention relates to protease variants comprising conservative mutations not pertaining the functional domain of the respective protease. Protease variants of this embodiment having proteolytic activity may be at least 70%, at least 75%, at least 80%, at least 85%, at least 90%, at least 91%, at least 92%, at least 93%, at least 94%, at least 95%, at least 96%, at least 97%, at least 98% or at least 99% similar to the full-length polypeptide sequence of the parent (wild-type) enzyme.

In one embodiment, protease variants have proteolytic activity according to the present invention when said protease variants exhibit increased proteolytic activity when compared to the parent protease.

A suitable subtilisin may be at least 80% identical to SEQ ID NO:22 as described in EP 1921147 and is characterized by comprising one amino acid (according to (a)-(h)) or combinations according to (i) together with the amino acid 101E, 101D, 101N, 101Q, 101A, 101G, or 101S (according to BPN′ numbering) and has proteolytic activity.

In one embodiment, a subtilisin is at least 80% identical to SEQ ID NO:22 as described in EP 1921147 and is characterized by comprising the mutation (according to BPN′ numbering) R101E, or S3T+V4I+V205I, or S3T+V4I+R101E+V205I or S3T+V4I+V199M+V205I+L217D, and has proteolytic activity.

In another embodiment, the subtilisin comprises an amino acid sequence having at least 80% identity to SEQ ID NO:22 as described in EP 1921147 and being further characterized by comprising S3T+V4I+S9R+A15T+V68A+D99S+R101S+A103S+I104V+N218D (according to the BPN′ numbering) and has proteolytic activity.

A subtilisin may have an amino acid sequence being at least 80% identical to SEQ ID NO:22 as described in EP 1921147 and being further characterized by comprising R101E, and one or more substitutions selected from the group consisting of S156D, L262E, Q137H, S3T, R45E,D,Q, P55N, T58W,Y,L, Q59D,M,N,T, G61 D,R, S87E, G97S, A98D,E,R, S106A,W, N117E, H120V,D,K,N, S125M, P129D, E136Q, S144W, S161T, S163A,G, Y171L, A172S, N185Q, V199M, Y209W, M222Q, N238H, V244T, N261T,D and L262N,Q,D (as described in WO 2016/096711 and according to the BPN′ numbering), and has proteolytic activity.

At least one protease may be selected from those commercially available including but not limited to those sold under the trade names Alcalase®, Blaze®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes A/S), those sold under the tradename Maxatase®, Maxacal®, Maxapem®, Purafect®, Purafect® Prime, Purafect MA®, Purafect Ox®, Purafect OxP®, Puramax®, Properase®, FN2®, FN3®, FN4®, Excellase®, Eraser®, Ultimase®, Opticlean®, Effectenz®, Preferenz® and Optimase® (Danisco/DuPont), Axapem™ (Gist-Brocases N.V.), Bacillus lentus Alkaline Protease (BLAP; sequence shown in FIG. 29 of U.S. Pat. No. 5,352,604) and variants thereof and KAP (Bacillus alkalophilus subtilisin) from Kao Corporation.

Known alignment methods comprise various methods that may be used to align two given nucleic acid or amino acid sequences and to calculate the degree of identity, see for example Arthur Lesk (2008), Introduction to bioinformatics, Oxford University Press, 2008, 3rd edition. In a preferred embodiment, the ClustalW software (Larkin, M. A., Blackshields, G., Brown, N. P., Chenna, R., McGettigan, P. A., McWilliam, H., Valentin, F., Wallace, I. M., Wilm, A., Lopez, R., Thompson, J. D., Gibson, T. J., Higgins, D. G. (2007): Clustal W and Clustal X version 2.0. Bioinformatics, 23, 2947-2948) is used applying default settings.

In preferred embodiments, the amylase and/or the protease of the inventive composition are wildtype (naturally occurring) enzymes or mutants thereof which still bind calcium.

In other preferred embodiments, the liquid cleaning composition of the invention comprises an amylase and a protease.

### EMBODIMENT 5

The liquid cleaning composition according to Embodiment 4(b), wherein the cleaning composition further comprises a protease stabilizing system comprising a peptide aldehyde.

In further embodiments, the liquid cleaning composition of the invention does not comprise boric acid, boronic acid and derivatives thereof. In even more preferred embodiments, the cleaning composition solely comprises one single protease stabilizing system, which is the protease stabilizing system comprising a peptide aldehyde.

Preferably, the liquid cleaning composition described herein comprises from about 0.001% to about 10%, from about 0.005% to about 8%, or from about 0.01% to about 6%, by weight of the composition, of an enzyme/protease stabilizing system. The enzyme/protease stabilizing system can be any stabilizing system which is compatible with the enzyme(s).

Preferably, the enzyme stabilizing system comprises at least one compound selected from the group consisting of polyols (preferably, 1,3-propanediol, ethylene glycol, glycerol, 1,2-propanediol, or sorbitol), inorganic salts (preferably, CaCl₂, MgCl₂, or NaCl), short chain (preferably, C1-C3) carboxylic acids or salts thereof (preferably, formic acid, formate (preferably, sodium formate), acetic acid, acetate, or lactate). More preferably, the protease stabilizing system comprising a peptide aldehyde is a peptide aldehyde selected from Z-VAL-H or Z-GAY-H, peptide acetals, and peptide aldehyde hydrosulfite adducts. Preferably, the protease stabilizing system may comprise a combination of at least two of the compounds selected (i) from the group consisting of salts, polyols, and short chain carboxylic acids and (ii) one or more of the compounds selected from the group consisting of peptide aldehydes, peptide acetals, and peptide aldehyde hydrosulfite adducts.

### EMBODIMENT 6

The liquid cleaning composition according to any one of Embodiments 1 to 5, wherein the at least one anionic surfactant
(a) is present in an amount ranging from 2% to 40%, preferably from to 3% to 30%, most preferably from 4% to 25% by weight of the composition; and/or
(b) is selected from the group consisting of linear alkylbenzenesulfonates (LAS), alkyl sulfates (AS), alkyl alkoxy sulfates (AExS), alkyl alkoxy carboxylates, modified alkylbenzene sulfonate (MLAS), methyl ester sulfonate (MES), alkyl sulfosuccinates and alpha-olefin sulfonate (AOS).

Nonlimiting examples of anionic surfactants—which may be employed also in combinations of more than one surfactant—useful herein include C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS), wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C8-C12-alkyl sulfates, of C12-C18-fatty alcohol ether sulfates, of C12-C18-fatty alcohol polyether sulfates, of sulfuric acid half-esters of ethoxylated C4-C12-alkylphenols (ethoxylation: 3 to 50 mol of ethylene oxide/mol), of C12-C18-alkylsulfonic acids, of C12-C18 alkyl sulfosuccinate, of C12-C18 sulfo fatty acid alkyl esters, for example of C12-C18 sulfo fatty acid methyl esters, of C10-C18-alkylarylsulfonic acids, preferably of n-C10-C18-alkylbenzene sulfonic acids, of C10-C18 alkyl alkoxy carboxylates and of soaps such as for example C8-C24-carboxylic acids. Preference is given to the alkali metal salts of the aforementioned compounds, particularly preferably the sodium salts.

In one embodiment of the present invention, anionic surfactants are selected from n-C10-C18-alkylbenzene sulfonic acids and from fatty alcohol polyether sulfates, which, within the context of the present invention, are in particular sulfuric acid half-esters of ethoxylated C12-C18-alkanols (ethoxylation: 1 to 50 mol of ethylene oxide/mol), preferably of n-C12-C18-alkanols.

In one embodiment of the present invention, also alcohol polyether sulfates derived from branched (i.e., synthetic) C11-C18-alkanols (ethoxylation: 1 to 50 mol of ethylene oxide/mol) may be employed.

Preferably, the alkoxylation group of both types of alkoxylated alkyl sulfates, based on C12-C18-fatty alcohols or based on branched (i.e., synthetic) C11-C18-alcohols, is an ethoxylation group and an average ethoxylation degree of any of the alkoxylated alkyl sulfates is 1 to 5, preferably 1 to 3.

In a further embodiment of the present invention, anionic surfactants are selected from biosurfactants, preferably rhamnolipids (RLs), mannosylerythritol lipids (MELs), trehalose lipids (TLs), cellobiose lipids (CLs) and/or sophorolipids (SLs).

In a preferred embodiment of the present invention, anionic surfactants are selected from C10-C15 linear alkylbenzenesulfonates, C10-C18 alkylethersulfates with 1-5 ethoxy units and C10-C18 alkylsulfates.

In case the liquid cleaning composition of the invention comprises more than one anionic surfactant, the amount ranging from 2% to 40%, preferably from to 3% to 30%, most preferably from 4% to 25% by weight of the composition refers to the total amount of all anionic surfactants (i.e., % first anionic surfactant+% second anionic surfactant+ . . . =% total anionic surfactant).

### EMBODIMENT 7

The liquid cleaning composition according to any one of Embodiments 1 to 6, wherein calcium (Ca²⁺) is present in an amount ranging from 0.0001% to 3%, preferably from 0.001% to 1% by weight of the composition.

In preferred embodiments, the lower limit of the calcium concentration is 0.0005%, 0.001% or 0.005% by weight of the inventive composition. In other preferred embodiments, the upper limit of the calcium concentration is 2.5%, 2% or 1.5% by weight of the inventive composition.

In further embodiments, the above-mentioned calcium (Ca²⁺) is free calcium. This means that it is neither part of a covalent interaction nor does it form (long-term) a salt interaction nor is it complexed by a builder (chelator).

Further, in preferred embodiments the liquid cleaning compositions of the invention comprise magnesium (Mg²⁺) in an amount ranging from 0.0001% to 3%, more preferably from 0.001% to 1% by weight of the composition.

In preferred embodiments, the lower limit of the magnesium concentration is 0.0005%, 0.001% or 0.005% by weight of the inventive composition. In other preferred embodiments, the upper limit of the calcium concentration is 2.5%, 2% or 1.5% by weight of the inventive composition.

In further embodiments, the above-mentioned magnesium (Mg²⁺) is free calcium. This means that it is neither part of a covalent interaction nor does it form (long-term) a salt interaction nor is it complexed by a builder (chelator).

Techniques to measure the concentration of calcium and/or magnesium are well-known in the art and include Atomic Absorption spectrometry (AA), Inductively Coupled Plasma Atomic Emission Spectroscopy (ICP-AES) and Inductively Coupled Plasma Mass Spectrometry (ICP-MS).

### EMBODIMENT 8

The liquid cleaning composition according to any one of Embodiments 1 to 7, wherein the viscosity ranges from 30 to 3000 mPa*s, preferably from 40 to 2500 mPa*s and most preferably from 50 to 2000 mPa*s.

In preferred embodiments, the lower limit of the viscosity of the inventive composition is 35 mPa*s or 45 mPa*s. In other preferred embodiments, the upper limit of the viscosity of the inventive composition is 2800 mPa*s, 2300 mPa*s or 2100 mPa*s.

All of the above-mentioned viscosity values are at 20 l/s and/or 20° C.

The viscosity can be measured by viscometers or rheometers well-known to the person skilled in the art.

### EMBODIMENT 9

The liquid cleaning composition according to any one of Embodiments 1 to 8, wherein pH-value ranges from 5 to 12, preferably from 6 to 10 and most preferably from 7 to 9.

The pH-value can be measured by using pH paper, colorimeters or sprectrophotometers. pH indicators are known in the art and include Gentian violet, Malachite green, Thymol blue, Methyl yellow, Methylene blue, Bromophenol blue, Congo red, Methyl orange, Screened methyl orange, Bromocresol green, Methyl red, Methyl purple, Azolitmin (litmus), Bromocresol purple, Bromothymol blue, Phenol red, Neutral red, Naphtholphthalein, Cresol red, Cresolphthalein, Phenolphthalein, Thymolphthalein, Alizarine Yellow R and Indigo carmine.

The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

### EMBODIMENT 10

The liquid cleaning composition according to any one of Embodiments 1 to 9, wherein the cleaning composition is a detergent composition. Alternatively, the liquid cleaning composition is an automatic dish wash (ADW) gel.

The phrase “cleaning composition”, as used herein, includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces. “Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below.

The cleaning compositions of the invention may be in any liquid form, namely, in the form of a liquid, paste, pouches, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); and other homogeneous, non-homogeneous or single-phase or multiphase cleaning product forms.

### EMBODIMENT 11

The liquid cleaning composition according to any one of Embodiments 1 to 10, wherein the cleaning composition further comprises at least one element of the group consisting of nonanionic surfactants, amphoteric surfactants, co-builders, alcohols, biocides, thickeners, water soluble polymers, clay soil removal/anti-redeposition agents, polymeric soil release agents, bleaching agents, bleach activators, brighteners, malodor control agents, pigments, dyes, opacifiers, hueing agents, dye transfer inhibiting agents, suds suppressors (antifoams), anti-corrosion agents, softeners and perfumes.

In preferred embodiments, the liquid cleaning composition of the invention comprises further enzymes asides the amylase and protease. The upper limit of the concentration of the further enzyme(s) is 5%, 3%, 2%, 1%, 0.5%, 0.1%, 0.01% or even 0% (meaning that the inventive composition lacks further enzymes asides the amylase and protease) by weight of the inventive composition In preferred embodiments, the liquid cleaning composition of the invention comprises further builder compounds asides EDDS. The upper limit of the concentration of the further builder compound(s) is 20%, 15%, %, 10%, 7%, 5%, 3%, 1%, 0.5% or even 0% (meaning that the inventive composition lacks further builder compounds asides EDDS) by weight of the inventive composition.

The cleaning compositions of the invention may—and preferably do—contain adjunct cleaning additives (also abbreviated herein as “adjuncts”), such adjuncts being preferably in addition to the components (i) to (v) as defined in Embodiment 1.

Suitable adjunct cleaning additives include further builders, cobuilders, structurants or thickeners, clay soil removal/anti-redeposition agents, polymeric soil release agents, dispersants such as polymeric dispersing agents, polymeric grease cleaning agents, solubilizing agents, further enzymes, enzyme stabilizing systems, further surfactants, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, dye fixation agent and perfumes.

Liquid cleaning compositions may comprise rheology control/modifying agents, emollients, humectants, skin rejuvenating actives, and solvents.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise the components (i) to (v) and, preferably, also further adjuncts, as the one described above and below in more detail.

Asides the anionic surfactant, the inventive liquid cleaning composition may contain an additional surfactant system that may be composed from one surfactant or from a combination of surfactants selected from non-ionic surfactants, cationic surfactants, zwitterionic surfactants, amphoteric surfactants, and mixtures thereof. Those of ordinary skill in the art will understand that a surfactant system for detergents encompasses any of the mentioned surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the additional cleaning composition comprises, by weight of the composition, from about 0.1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from nonionic surfactants, cationic surfactants, zwitterionic surfactants, amphoteric surfactants, and mixtures thereof.

Non-limiting examples of nonionic surfactants—which may be employed also in combinations of more than one other surfactant—include: C8-C18 alkyl ethoxylates, such as, NEODOL® non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides).

Non-limiting examples of nonionic surfactants—which may be employed also in combinations of more than one other surfactant—include: C8-C18 alkyl ethoxylates, such as, NEODOL® non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides).

Preferred examples of alkoxylated alcohols and alkoxylated fatty alcohols are, for example, compounds of the general formula (A)

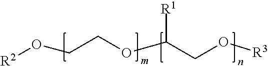

in which the variables are defined as follows:
R1 is selected from linear C1-C10-alkyl, preferably ethyl and particularly preferably methyl,
R2 is selected from C8-C22-alkyl, for example n-C8H17, n-C10H21, n-C12H25, n-C14H29, n-C16H33 or n-C18H37,
R3 is selected from C1-C10-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one.

Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

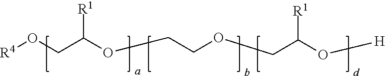

in which the variables are defined as follows:
R1 is identical or different and selected from linear C1-C4-alkyl, preferably identical in each case and ethyl and particularly preferably methyl,
R4 is selected from C6-C20-alkyl, in particular n-C8H17, n-C10H21, n-C12H25, n-C14H29, n-C16H33, n-C18H37,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present.

In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 4-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R1=C8-18 alkyl moiety and two R2 and R3 moieties selected from the group consisting of C1-C3 alkyl groups and C1-C3 hydroxyalkyl groups. Preferably, the amine oxide is characterized by the formula

R1-N(R2)(R3)-O
wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably the two moieties are selected from a C1-C3 alkyl, more preferably both are selected as a C1 alkyl.

In a preferred embodiment of the present invention, amphoteric surfactants are selected from C8-C18 alkyl-dimethyl aminoxides and C8-C18 alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C12-C18-alkylbetaines and sulfobetaines. The zwitterionic surfactant preferably is a betaine surfactant, more preferably a Cocoamidopropylbetaine surfactant. Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may or may not comprise one additional builder further to EDDS. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In preferred embodiments, the additional builder is diethylenetriamine penta(methylene phosphonic acid) (DTPMP).

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the composition or laundry formulation according to the invention comprises additionally at least one enzyme in addition to an amylase and a protease.

In even more preferred embodiments, calcium and/or magnesium is not a co-factor or otherwise required for the catalytic activity of the additional enzyme(s).

Preferably, the at least one additional enzyme is a detergent enzyme.

In one embodiment, the additional enzyme is classified as an oxidoreductase (EC 1), a transferase (EC 2), a hydrolase (EC 3), a lyase (EC 4), an isomerase (EC 5), or a ligase (EC 6). The EC-numbering is according to Enzyme Nomenclature, Recommendations (1992) of the Nomenclature Committee of the International Union of Biochemistry and Molecular Biology including its supplements published 1993-1999. Preferably, the enzyme is a hydrolase (EC 3).

In a preferred embodiment, the additional enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the additional enzyme is a mannanse and/or a lipase.

The additional enzyme(s) can be incorporated into the composition at levels sufficient to provide an effective amount for achieving a beneficial effect, preferably for primary washing effects and/or secondary washing effects, like anti-greying or antipilling effects (e.g., in case of cellulases). Preferably, the additional enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition.

Compositions according to the invention may comprise one or more bleaching agent (bleaches). Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, (S)NOBS, LOBS, DOBA, PAP, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

As precursors of H₂O₂ peroxides come into consideration, i. e. every compound which is capable of yielding hydrogen peroxide in aqueous solutions, for example, the organic and inorganic peroxides known in the literature and available commercially that bleach textile materials at conventional washing temperatures, for example at from 10 to 95° C.

Preferably, however, inorganic peroxides are used, for example persulfates, perborates, percarbonates and/or persilicates. They are typically used in an amount of 2-80 wt-%, preferably of 4-30 wt-%, based on the weight of the composition.

Typically the compound of formula (1)

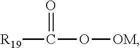

as described in more detail below, is present in the composition in an amount of 0.05-15 wt-%, preferably from 0.1 to 10 wt-%, based on the weight of the total composition.

Examples of suitable inorganic peroxides are sodium perborate tetrahydrate or sodium perborate monohydrate, sodium percarbonate, inorganic peroxyacid compounds, such as for example potassium monopersulphate (MPS). If organic or inorganic peroxyacids are used as the peroxygen compound, the amount thereof will normally be within the range of about 2-80 wt-%, preferably from 4-30 wt-%, based on the weight of the composition.

The organic peroxides are, for example, mono- or poly-peroxides, urea peroxides, a combination of a C1-C4alkanol oxidase and C1-C4alkanol (Such as methanol oxidase and ethanol as described in WO95/07972), alkylhydroxy peroxides, such as cumene hydroperoxide and t-butyl hydroperoxide.

The peroxides may be in a variety of crystalline forms and have different water contents, and they may also be used together with other inorganic or organic compounds in order to improve their storage stability.

As oxidants, peroxo acids can also be used. One example are organic mono peracids of formula (1),

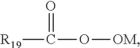

wherein
M signifies hydrogen or a cation,
R₁₉ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted.

Preferred mono organic peroxy acids and their salts are those of formula

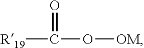

wherein
M signifies hydrogen or an alkali metal, and
R′₁₉ signifies unsubstituted C₁-C₄alkyl; phenyl; —C1-C2alkylene-phenyl or phthalimidoC₁-C₈alkylene.

Especially preferred is CH₃COOOH and its alkali salts.

Especially preferred is also s-phthalimido peroxy hexanoic acid and its alkali salts (PAP).

Also suitable are diperoxyacids, for example, 1,12-diperoxydodecanedioic acid (DPDA), 1,9-diperoxyazelaic acid, diperoxybrassilic acid, diperoxysebasic acid, diperoxyisophthalic acid, 2-decyldiperoxybutane-1,4-diotic acid and 4,4′-sulphonylbisperoxybenzoic acid.

In some cases the use of an additional bleach activator may be of advantage.

The term bleach activator is frequently used as a synonym for peroxyacid bleach precursor. All the above mentioned peroxy compounds may be utilized alone or in conjunction with a peroxyacid bleach precursor.

Such precursors are the corresponding carboxyacid or the corresponding carboxyanhydride or the corresponding carbonylchlorid, or amides, or esters, which can form the peroxy acids on perhydrolysis. Such reactions are commonly known.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N,N-diacetyl-N,N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (10):

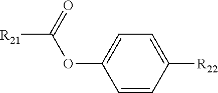

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; acylated polyhydric alcohols, especially triacetin, ethylene glycol diacetate and 2,5-diacetoxy-2,5-dihydrofuran; and also acetylated sorbitol and mannitol and acylated sugar derivatives, especially pentaacetylglucose (PAG), sucrose polyacetate (SUPA), penta-acetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N,N,N-trimethyl ammonium) ethyl sodium-4-sulphonphenyl carbonate chloride—(SPCC), N-octyl,N,N-dimehyl-N10-carbophenoxy decyl ammonium chloride—(ODC), 3-(N,N,N-trimethyl ammonium) propyl sodium-4-sulphophenyl carboxylate and N,N,N-trimethyl ammonium toluyloxy benzene sulphonate.

It is also possible to use additional bleach catalysts, which are commonly known, for example transition metal complexes as disclosed in EP 1194514, EP 1383857 or WO04/007657.

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise cleaning polymers and/or soil release polymers.

The cleaning polymers may include, without limitation, “multifunctional alkoxylated polyethylene imines” (for example BASF's Sokalan® HP20), “multifunctional alkoxylated diamines” (for example BASF's Sokalan® HP96), BASF's Sokalan® SR400 A and also terephthalic acid-based polyesters like Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional alkoxylated polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional alkoxylated diamines are typically ethoxylated C2 to C12 alkylene diamines, preferably hexamethylene diamine, which are further quaternized and optionally sulfated. Typical multifunctional alkoxylated diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional alkoxylated polyethylene imine and/or at least one multifunctional alkoxylated diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents.

In another preferred embodiment of the present invention, the cleaning compositions may contain at least one terephthalic acid-based polyester, employed as soil release polymer, to improve the whiteness of the fabrics after the wash, especially the whiteness of polyester fabrics.

Thus, one aspect of the present invention is a laundry detergent composition, the liquid laundry detergent, comprising at least one compound selected from multifunctional alkoxylated polyethylene imines, multifunctional alkoxylated diamines and terephthalic acid-based polyesters, and mixtures thereof.

The inventive cleaning compostion may also comprise at least one antimicrobial agent (also often named preservatives).

The composition may contain one or more antimicrobial agents and/or preservatives as listed in patent WO2021/115912 A1 on pages 35 to 39.

Especially of interest are the following antimicrobial agents and/or preservatives: 4,4′-dichloro 2-hydroxydiphenyl ether (CAS-No. 3380-30-1), further names: 5-chloro-2-(4-chlorophenoxy) phenol, Diclosan, DCPP, which is commercially avail-able as a solution of 30 wt % of 4,4′-dichloro 2-hydroxydiphenyl ether in 1,2 propyl-eneglycol under the trade name Tinosan® HP 100 (BASF); 2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE); 2-bromo-2-nitropropane-1,3-diol (CAS-No. 52-51-7, further names: 2-bromo-2-nitro-1,3-propanediol, Bronopol®, Protectol® BN, Myacide AS); Glutaraldehyde (CAS-No. 111-30-8, further names: 1-5-pentandial, pentane-1,5-dial, glutaral, glutardialdehyde, Protectol® GA, Protectol® GA 50, Myacide® GA); Glyoxal (CAS No. 107-22-2; further names: ethandial, oxylaldehyde, 1,2-ethandial, Protectol® GL); 2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3(2H)-one (BIT, CAS No. 2634-33-5); Hexa-2,4-dienoic acid (Sorbic acid, CAS No. 110-44-1) and its salts, e.g. calcium sorbate, sodium sorbate, potassium (E,E)-hexa-2,4-dienoate (Potassium Sorbate, CAS No. 24634-61-5); Lactic acid and its salts; L-(+)-lactic acid (CAS No. 79-33-4); Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate; Salicylic acid and its salts, e.g. calcium salicylate, magnesium salicylate, MEA salicylate, sodium salicylate, potassium salicylate, TEA salicylate; Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9); Didecyldimethylammonium chloride (DDAC, CAS No. 68424-95-3 and CAS No. 7173-51-5); N-(3-aminopropyl)-N-dodecylpropane-1,3-diamine (Diamine, CAS No. 2372-82-9); Peracetic acid (CAS No. 79-21-0); Hydrogen peroxide (CAS No. 7722-84-1).

The antimicrobial agent is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further encompasses a method of preserving the aqueous (liquid) composition according to the invention against microbial contamination or growth, which method comprises addition of 2-Phenoxyethanol. The invention thus further encompasses a method of providing an antimicrobial effect on textiles after treatment with a solid laundry detergent e.g., powders, granulates, capsules, tablets, bars etc.), a liquid laundry detergent, a softener or an after rinse containing 4,4′-dichloro 2-hydroxydiphenyl ether (DCPP).

In a further embodiment, this invention also encompasses a composition further comprising an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

The term “dye fixation agent”, as used herein, relates to compounds that attenuate or even terminate dye bleeding of colored fabrics during the washing process. Dye fixation agents include, but are not limited to cationic dye fixation agents, crosslinking fixation agents and formaldehyde-based fixation agents. The skilled person is well-aware of these compounds and may purchase commercially available products from BASF SE, Huntsman, Archroma, Fineotex, Biotex Malaysia or Dystar. Exemplified, but not limiting dye fixation agents are Basilen Fixing Agent F-RP, Albafix ECO, Finofix NF, poly DADMAC, Polyamine (DCDA-DETA, Epichloro-DMA, Epichloro-DETA, etc.).

Formulations according to the invention may also comprise water and/or additional organic solvents, e.g., ethanol or propylene glycol.

Further optional ingredients may be but are not limited to viscosity modifiers, foam boosting or foam reducing agents, perfumes, dyes, optical brighteners, and dye transfer inhibiting agents.

### EMBODIMENT 12

Use of the liquid cleaning composition according to any one of Embodiments 1 to 11 for cleaning of fabrics.

The term “fabric”, as used herein, applies to any type of cloth or textile, such as but not limited to upholstery and carpeting, comprising natural and/or synthetic materials.

### EMBODIMENT 13

A cleaning method comprising contacting the liquid cleaning composition according to any one of Embodiments 1 to 11 and fabrics.

The term “cleaning”, as used herein, refers to performing or aiding in any soil removal, bleaching, microbial population reduction, or combination thereof. This includes to rinse a fabric with water or to wash the fabric with the inventive liquid cleaning composition by means of a washing machine, automatic dish washer or by hand. It is preferred that the cleaning is carried out at a temperature of 60° C. or less, more preferably at a temperature of 40° C. or less, most preferably at a temperature of 30° C. or less. In other preferred embodiments, the cleaning method is performed under water conserving conditions. This means that not more than 60%, not more than 70%, not more than 80%, not more than 90% or not more than 95% of the water generally recommended for a given cleaning procedure is used for the cleaning method of the present invention.

### EMBODIMENT 14

A method of manufacturing a liquid cleaning composition comprising bringing in contact the components (i) to (v) of Embodiment 1 and mixing them.

The term “contacting” or “bringing into contact” as interchangeably used herein, refers to the act of bringing together two or more components, preferably all components (i) to (v) by dissolving, suspending, blending, slurrying, or stirring. By the term “mixing”, as used herein, it is meant to blend, disperse or emulsify the components (i) to (v) of the liquid cleaning composition of the invention to arrive at a random or substantially equal distribution of all components (i) to (v). One or both above-mentioned steps may be carried out in solid state. Alternatively, two or more components, preferably all components (i) to (v) are “contacted” and “mixed” in a liquid, preferably water.

### General Cleaning Compositions and Formulations

The following compositions shown below including those in the tables disclose general cleaning compositions of certain types, which correspond to typical compositions correlating with typical washing conditions as typically employed in various regions and countries of the world.

When the shown composition does not comprise at least one component of (i) to (v), especially EDDS, such composition is a comparative composition. When it comprises all components of (i) to (v), in the amounts that are described herein, such compositions are considered to fall within the scope of the present invention.

Liquid laundry detergents according to the present invention with a calcium (Ca²⁺) amount ranging from 0.000001% to 5% by weight of the composition, having a viscosity ranging from 20 to 10000 mPa*s and a pH-value ranging between 4 and 14 are composed of:

| | |
|---|---|
| 0.0005-20% | of EDDS |
| 0.1-50% | of anionic surfactants |
| 0.1-40% | of other builders, cobuilders and/or chelating agents |
| 0.000001-5% | of protease or amylase or protease and amylase |
| 0.1-50% | other adjuncts |
| water | to add up 100%. |

Preferred liquid laundry detergents according to the present invention with a calcium (Ca²⁺) amount ranging from 0.0001% to 3% by weight of the composition, having a viscosity ranging from 30 to 3000 mPa*s and a pH-value ranging between 5 and 12 are composed of:

| | |
|---|---|
| 0.001-15% | of EDDS |
| 2-40% | of anionic surfactants selected from C10-C15-LAS (alkyl benzene sulfonic |
| | acid) and/or C10-C18 alkyl ether sulfates containing 1-5 ethoxy-units |
| 1.5-10% | of nonionic surfactants selected from C10-C18-alkyl ethoxylates containing |
| | 3-10 ethoxy-units |
| 2-20% | of soluble organic builders/ cobuilders selected from C10-C18 fatty acids, |
| | di- and tricarboxylic acids, hydroxy-di- and hydroxytricaboxylic acids and |
| | polycarboxylic acids |
| 0.0001-1% | of protease or amylase or protease and amylase |
| 0.5-20% | of mono- or diols selected from ethanol, isopropanol, ethylene glycol, or |
| | propylene glycol |
| 0.1-20% | other adjuncts |
| water | to add up to 100%. |

In a preferred embodiment the composition according to the present invention is used in a manual dish wash detergent.

Liquid manual dish wash detergents according to the present invention are composed of:

| | |
|---|---|
| 0.05-10% | of EDDS |
| 1-50% | of surfactants |
| 0.1-50% | of other adjuncts |
| water | to add up 100%. |

Preferred liquid manual dish wash detergents according to the present invention are composed of:

| | |
|---|---|
| 0.2-5% | of EDDS |
| 5-40% | of anionic surfactants selected from C10-C15- LAS, C10-C18 |
| | alkyl ether sulfates containing 1-5 ethoxy-units, and |
| | C10-C18 alkyl sulfate |
| 0-10% | of Cocamidopropylbetaine |
| 0-10% | of Lauramine oxide |
| 0-2% | of a non-ionic surfactant, preferably a C10-Guerbet alcohol |
| | alkoxylate |
| 0-5% | of an enzyme, preferably Amylase, and preferably also an |
| | enzyme stabilizing system |
| 0.5-20% | of mono- or diols selected from ethanol, isopropanol, |
| | ethylene glycol, or propylene glyclol |
| 0.1-20% | other adjuncts |
| water | to add up to 100%. |

Both of the above liquid manual dish wash detergents have a calcium (Ca²⁺) amount ranging from 0.0001% to 3% by weight of the composition, having a viscosity ranging from 30 to 3000 mPa*s and a pH-value ranging between 5 and 12.

### ADW Gel Formulations

In further embodiment, the composition according to the present invention is used in an automatic dish wash (ADW) gel formulation.

Preferred ADW gel formulations according to the present invention are composed of:

| | |
|---|---|
| 0.05-20% | of EDDS |
| 0.1-0.5% | of anionic surfactants |
| 1-20% | of nonionic surfactants |
| 0.1-50% | of builders, cobuilders and/or chelating agents |
| 0.1-50% | other adjuncts |
| water | to add up 100%. |

Preferred ADW Gels according to the present invention are composed of:

| | |
|---|---|
| 0.2-20% | of EDDS |
| 0.1-0.5% | of anionic surfactants selected from linear alkylbenzenesulfonates (LAS), |
| | alkyl sulfates (AS), alkyl alkoxy sulfates (AES), modified alkylbenzene sulfonate |
| | (MLAS), methyl ester sulfonate (MES) and alpha-olefin sulfonate (AOS) |
| 1-5% | of nonionic surfactants selected from hydroxy mixed ethers, alcohol |
| | ethoxylates, alcohol alkoxylates |
| 1-7% | of polymers (e.g.polyacrylates, polyacrylates with sulfogroup containing |
| | monomers, biodegradable polymers (polyaspa, PESA, biograftpolymers)) |
| 2-20% | chelating agent like citrate, methyl glycine diacetic acid, GLDA |
| 0.05-5% | of an enzyme system containing at least one enzyme suitable for detergent |
| | use and preferably also an enzyme stabilizing system; protease and amylase |
| | system |
| 0.1-50% | other adjuncts (parfum, solvents, thickener, preservative, colourant, |
| | polyethyleneimine, amphoteric polymer, Sodium formate, calcium chloride, |
| | sodium sulfate, sodium hydroxide, sodium carbonate, sodium silicate, sodium |
| | bicarbonate, sodium chloride, Zinc salt, benzothiazoline) |
| water | to add up to 100%. |

Both of the above automatic dish wash (ADW) gel formulations have a calcium (Ca²⁺) amount ranging from 0.0001% to 3% by weight of the composition, having a viscosity ranging from 30 to 3000 mPa*s and a pH-value ranging between 5 and 12.

The components (i) to (v) according to claim 1 and also the other components of the cleaning composition can be separated by formulating them in different compartments, such as different compartments of multi-chamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world.

TABLE 1
General formula for laundry detergent compositions according to
the invention with a calcium (Ca²⁺) amount ranging from 0.000001%
to 5% by weight of the composition, having a viscosity ranging
from 20 to 10000 mPa*s and a pH-value ranging between 4 and 14:

| | Ranges of Ingredient in |
|---|---|
| Ingredient | Liquid frame formulations |
| Linear alkyl benzene sulphonic acid | 0 to 30% |
| Coco fatty acid | 0 to 12% |
| Fatty alcohol ether sulphate | 1 to 25% |
| NaOH or mono- or triethanolamine | Up to pH 7.0 to 9.0 |
| Alcohol ethoxylate | 1 to 30% |
| 1,2-Propylene glycol | 0 to 10% |
| Ethanol | 0 to 4% |
| Sodium citrate | 0 to 8% |
| Amylase or protease | 0.000001 to 5% |
| EDDS | 0.0005 to 20% |
| water | Up to 100% |

TABLE 2
Liquid laundry frame formulations:

| | (numbers: % active) | | | | | |
|---|---|---|---|---|---|---|
| active | F1 | F2 | F3 | F4 | F5 | F6 |
| alcohol ethoxylate | 5.40 | 10.80 | 12.40 | 7.30 | 1.60 | 7.60 |
| 7EO | | | | | | |
| Coco fatty acid | 2.40 | 3.10 | 3.20 | 3.20 | 3.50 | 6.40 |
| K12-18 | | | | | | |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propane diol | 6.00 | 3.50 | 8.70 | 8.70 | 1.10 | 7.80 |
| Triethanolamine | | | | | | |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| EDDS * | 0.0005- | 0.0005- | 0.0005- | 0.0005- | 0.0005- | 0.0005- |
| | 20 | 20 | 20 | 20 | 20 | 20 |
| Amylase or protease | 0.000001- | 0.000001- | 0.000001- | 0.000001- | 0.000001- | 0.000001- |
| | 5 | 5 | 5 | 5 | 5 | 5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| Ca²⁺ | 0.0010 | 0.0010 | 0.0010 | 0.0010 | 0.0015 | 0.0012 |
| water | to 100 | to 100 | to 100 | to 100 | to 100 | to 100 |
| pH Value | 7.8 | 7.9 | 8.5 | 8.2 | 8.9 | 9.0 |
| Viscosity | 121 | 520 | 210 | 195 | 318 | 570 |

Liquid laundry frame formulations according to the invention:

| | (numbers: % active) | | | | | | | |
|---|---|---|---|---|---|---|---|---|
| active | F7 | F8 | F9 | F10 | F11 | F12 | F13 | F14 |
| alcohol ethoxylate | 3.80 | 0.30 | 13.30 | 8.00 | 5.70 | 20.00 | 9.20 | 29.00 |
| 7EO | | | | | | | | |
| Coco fatty acid | 2.80 | 3.00 | 1.70 | 1.80 | 2.50 | 5.00 | 8.60 | 10.40 |
| K12-18 | | | | | | | | |
| Fatty alcohol ether | 2.80 | 4.50 | 3.90 | 4.10 | | 10.00 | 22.20 | |
| sulphate | | | | | | | | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propane diol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| EDDS * | 0.0005- | 0.0005- | 0.0005- | 0.0005- | 0.0005- | 0.0005- | 0-5 | 0-5 |
| | 20 | 20 | 20 | 20 | 20 | 20 | | |
| Protease | 0.000001- | 0.000001- | 0.000001- | 0.000001- | 0.000001- | 0.000001- | 0.000001- | 0.000001- |
| | 5 | 5 | 5 | 5 | 5 | 5 | 5 | 5 |
| Amylase | 0.000001- | 0.000001- | 0.000001- | 0.000001- | 0.000001- | 0.000001- | 0.000001- | 0.000001- |
| | 5 | 5 | 5 | 5 | 5 | 5 | 5 | 5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| Ca²⁺ | 0.0013 | 0.0012 | 0.0012 | 0.0010 | 0.0010 | 0.0010 | 0.0010 | 0.0010 |
| water | to 100 | to 100 | to 100 | to 100 | to 100 | to 100 | to 100 | to 100 |
| pH Value | 8.5 | 8.1 | 7.9 | 7.1 | 7.4 | 9.0 | 7.7 | 7.9 |
| Viscosity | 304 | 234 | 390 | 297 | 120 | 483 | 570 | 75 |

* Without EDDS the formulations are comparative examples.

The following examples shall further illustrate the present invention without restricting the scope of the invention.

The specific embodiments as described throughout this disclosure are encompassed by the present invention as part of this invention; the various further options being disclosed in this present specification as “optional”, “preferred” ~, “more preferred” ~, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### EXAMPLES

I) Storage Experiments with Amylase

The storage stability amylase was determined by an enzymatic activity assay in liquid detergents after storage for up to 28 days at 38° C.

To test the storage stability of amylase, liquid laundry test formulation F15 was prepared with 1 or 2.2% EDDS, 2.2% GLDA, 2.2% citrate, 2.2% DTPA, a mixture of 1.5% citrate and 0.7% GLDA. Table 3 shows the liquid laundry detergents that have been used to carry out the application tests to determine the impact of the builders on enzyme stability by testing the amylase activity. All formulations were stored for 1, 2, 7, 14 or 28 days at 38° C.

TABLE 1
Composition of the liquid detergent formulation
tested for amylase stability

| | F15 |
|---|---|
| Solid content prior to addition of | about 33% |
| inventive compounds (non H₂O) | |
| LAS | 17.70% |
| AES | 44.62% |
| AEO | 6.26 |
| Coco fatty acid soap | 1.80% |
| NaOH (50%) | 0.68% |
| Chelate (variable) | 2.20% |
| Propylene glycol | 6.00% |
| Ethanol | 2.00% |
| Enzyme | 0.4% amylase product |
| ad H₂O | Up to 100% |
| pH | 8.5 |
| Ca²⁺ | 0.0014% |
| Viscosity | 800 mPa*s |

LAS: anionic surfactant; linear dodecylbenzene sulfonic acid (CAS 27176-87-0): Biosoft ® D-40 (~38% active) (Stepan)
AES (alkyl ether sulphates); anionic surfactant; poly(oxy-1,2-ethanediyl), .alpha.-sulfo-.omega.-hydroxy-, C₁₂₋₁₄-alkyl ethers, sodium salts (CAS 68891-38-3): Standapol ® ES-3 K (~28% active)
AEO (alcohol ethoxylate): non-ionic surfactant; C₁₂C₁₄ Fatty Alcohol (6.5 EO): Lutensol ® A 65 N (~100% active)
Chelate: sodium citrate dihydrate, DTPA (Trilon ® C Liquid, ~42% active), EDDS (~35% active),
GLDA (Dissolvine@ GL-47-S, ~47% active) (Nouryon), or a combination thereof.
protease product: Lavergy ® Pro 106 LS

The liquid detergent formulations were stored at a temperature of 38° C. for up to 4 weeks. A 4-week storage is said to correspond to a storage of approximately 9 months at room temperature or >15 month at 8° C.

The amylase activity after storage was measured quantitatively by the release of the chromophore para-nitrophenol (pNP) from the substrate Ethyliden-blocked-pNPG7(Roche Applied Science, material number 10880078103). The alpha-amylase degrades the substrate into smaller molecules and α-glucosidase (Roche Applied Science, material number 11626329103), which is added in excess compared to the α-amylase, process these smaller products until pNP is released; the release of pNP, measured via an increase of absorption at 405 nm, is directly proportional to the α-amylase activity of the sample. Amylase standard: Termamyl 120 L (Sigma 3403). Amylolytic activity was determined before and after storage.

Residual enzyme activity corresponds to the enzyme activity remaining when compared to the initial enzyme activity available before storage at time 0.

### Test Results

### Amylase % Relative Activity in Enzymatic Assay

| | Start | | | | | |
|---|---|---|---|---|---|---|
| Builder | (day 0) | Day 1 | Day 2 | Day 7 | Day 14 | Day 28 |
| 2.2% EDDS | 100% | 95% | 97% | 91% | 84% | 73% |
| 2.2% GLDA | 100% | 67% | 48% | 20% | 10% | 4% |
| 2.2% Citrate | 100% | 89% | 89% | 72% | 51% | 24% |
| 2.2% DTPA | 100% | 39% | 18% | 2% | 1% | 0% |
| 1.7% Citrate + | 100% | 90% | 92% | 78% | 59% | 40% |
| 0.7% GLDA | | | | | | |

The standard error for each of the above values is 2.5% or less. The inventive composition comprising EDDS therefore exhibits significant benefits on enzyme stability.

II) Storage Application Experiments with Amylase and Protease

The storage stability of protease and amylase was determined by residual washing performance in liquid detergents after storage for up to 28 days at 37° C.

To test the storage stability of protease and amylase, liquid laundry test formulation F16 was prepared with no builder, 1 or 2% EDDS, 1 or 2% GLDA, 0.5 or 1% HEDP and 0.5 or 1% DTPMP. Table 4 shows the liquid laundry detergents that have been used to carry out the application tests to determine the impact of the builders on enzyme stability by testing the primary cleaning performance. All formulations were stored for 7, 14 or 28 days at 37° C. After the storage time, the formulations were washed using two different methods.

TABLE 4
Liquid laundry test formulations according to the invention:

| active | |
|---|---|
| (numbers: % active) | F16 |
| alcohol ethoxylate 7EO | 8.30¹ |
| Coco fatty acid K12-18 | 7.00 |
| Fatty alcohol ether sulphate, | 15.10 |
| Texapon N70 | |
| Linear alkyl benzene sulphonic | 0.00 |
| acid, Maranil DBS/LC | |
| 1,2 Propane diol | 0.00 |
| Cumene sulfonate | 1.50 |
| Isopropanole | 0.50 |
| NaOH | 1.40 |
| Glycerol | |
| Ethanol | 2.80 |
| Na citrate | 3.70 |
| Builder | 0-2 |
| Protease (product as is) | 1.00 |
| Amylase (product as is) | 0.20 |
| Ca²⁺ | 0.00010 |
| water | to 100 |
| pH Value | 8.1 |
| Viscosity | 230 |

¹NIS1: non-ionic surfactant; C₁₃C₁₅ Oxo Alcohol Ethoxylate (7 EO): Dehydol LT 7
protease product: Lavergy ® PRO 114 LS (BASF)
amylase product: Amplify ® prime 100 L (Novozymes)

### A) Application Test in HTS (High Throughput System); Small Scale

The washing performance for the formulations was determined as follows.

The L*, a* b* values of the single stains are measured before wash with a MACH 5 from CFT/Colour consult. Then the fabrics are washed at 30° C. in detergent formulations. After the wash the fabrics are rinsed and dried.

The washing performance for the single stains is determined by measuring the L*, a* b* values with a MACH 5 from CFT/Colour consult after drying. The dE value is calculated from the single values before and after wash. Values are a mean value of 3 replicates. The higher the value, the better the performance.

### Washing Conditions:

| Test equipment | High throughput system | |
|---|---|---|
| Washing liquor | 2.5 to 3 | ml |
| Washing time/temperature | 20 min at 30 °C | |
| Detergent Dosage | 3 | g/L |

| | |
|---|---|
| Fabric/liquor ratio | 1:38 |
| Washing cycles | 1 (3 replicates) |
| Water hardness | 2.5 mmol/l Ca²⁺:Mg²⁺:HCO₃⁻ 4:1:8 |
| Soiled fabric for amylase | EMPA 161 (starch on cotton) |
| Soiled fabric for | CFT PC 05 (blood/milk/ink on |
| protease | polyester/cotton) |
| | CFT CS 38 (egg yolk on cotton) |

Producer: Center for Testmaterials BV, NL-3130 AC Vlaardingen; Swissatest Testmaterialien AG, Mövenstraße 12, CH-9015 St. Gallen

### Test Results

### Amylase (HTS-F16-EMPA 161) Delta E Values

| Builder | Start (day 0) | Day 7 | Day 14 | Day 28 |
|---|---|---|---|---|
| Without builder | 9.1 | 2.3 | 0.7 | 0.7 |
| 1% EDDS | 8.8 | 6.6 | 5.2 | 3.4 |
| 2% EDDS | 9.0 | 6.9 | 5.3 | 2.7 |
| 1% GLDA | 8.5 | 3.1 | 1.6 | 0.9 |
| 2% GLDA | 8.4 | 4.3 | 2.4 | 1.0 |

Polyphosphonate controls

| | | | | |
|---|---|---|---|---|
| 0.5% HEDP | 9.0 | 2.3 | 0.8 | 0.6 |
| 1% HEDP | 8.6 | 2.2 | 1.0 | 0.8 |
| 0.5% DTPMP | 9.3 | 6.9 | 5.6 | 3.2 |

| Builder | Start (day 0) | Day 7 | Day 14 | Day 28 |
|---|---|---|---|---|
| Without builder | 13.2 | 10.8 | 8.8 | 5.1 |
| 1% EDDS | 14.3 | 12.4 | 12.5 | 11.5 |
| 2% EDDS | 14.1 | 12.5 | 12.7 | 11.8 |
| 1% GLDA | 13.7 | 8.8 | 5.9 | 3.3 |
| 2% GLDA | 13.7 | 10.5 | 8.7 | 5.0 |

Polyphosphonate controls

| | | | | |
|---|---|---|---|---|
| 0.5% HEDP | 16.2 | 13.1 | 5.4 | 2.7 |
| 1% HEDP | 14.5 | 7.4 | 4.6 | 2.8 |
| 0.5% DTPMP | 14.7 | 13.9 | 13.8 | 12.5 |
| 1% DTPMP | 12.7 | 14.8 | 13.8 | 12.5 |

| Builder | Start (day 0) | Day 7 | Day 14 | Day 28 |
|---|---|---|---|---|
| Without builder | 7.5 | 5.9 | 5.0 | 2.9 |
| 1% EDDS | 9.2 | 7.8 | 7.9 | 6.8 |
| 2% EDDS | 7.5 | 7.4 | 7.5 | 7.0 |
| 1% GLDA | 7.9 | 4.7 | 3.5 | 1.3 |
| 2% GLDA | 8.6 | 6.7 | 5.1 | 3.2 |

Polyphosphonate controls

| | | | | |
|---|---|---|---|---|
| 0.5% HEDP | 9.9 | 5.9 | 2.4 | 0.3 |
| 1% HEDP | 7.7 | 5.4 | 2.3 | 0.3 |
| 0.5% DTPMP | 7.7 | 6.9 | 6.4 | 5.6 |
| 1% DTPMP | 7.0 | 8.4 | 8.0 | 7.4 |

The error of the measurement is +/−0.5 delta E units. Therefore, any value >0.5 (delta delta E) means that EDDS (in the context of the tested composition) exhibits a directional and visible contribution to the overall stability of the respective detergent formulation.

### B) Application Test in Launder-O-Meter; Larger Scale

The washing performance for the formulations was determined as follows.

The L*, a* b* values of the single stains on multi soil monitors (8 different protease relevant stains) are measured before wash with a MACH 5 from CFT/Colour consult. Then the fabrics are washed together with cotton ballast fabric and 20 steel balls at 30° C. in detergent formulations. After the wash the fabrics are rinsed, spin-dried and dried in the air.

The washing performance for the single stains is determined by measuring the L*, a* b* values with a MACH 5 from CFT/Colour consult after drying. The dE value is calculated from the single values before and after wash. All 8 stains from the monitor are summed up. The higher the value, the better the performance.

### Washing Conditions:

| Test equipment | Launder-o-meter, LP2 Typ, | |
|---|---|---|
| | SDL Atlas Inc., USA | |
| Washing liquor | 250 | ml |
| Washing time/temperature | 20 min at 30 °C | |
| Dosage | 3 g detergent/L | |
| Fabric/liquor ratio | 1:12.5 | |
| Washing cycles | 1 | |
| Water hardness | 2.5 mmol/l Ca²⁺:Mg²⁺:HCO₃⁻ 4:1:8 | |
| Ballast fabric | 2.5 g cotton fabric 283 | |
| Sum ballast + soiled fabric | 20 | g |

| | |
|---|---|
| Multi soil monitor for | CFT-C-S 01 (blood) |
| protease | CFT-C-11 (pigment/oil/milk) |
| | CFT-C-S 07 (grass) |
| | CFT-C-S 38 (egg yolk) |
| | CFT-C-S 39 (full egg) |
| | CFT-P-C 05 (blood milk ink on |
| | polyester/cotton) |
| | EMPA 112 (cocoa on cotton) |
| | EMPA 116 (blood milk ink on cotton) |

Producer: Center for Testmaterials BV, NL-3130 AC Vlaardingen; Swissatest Testmaterialien AG, Mövenstraße 12, CH-9015 St. Gallen

### Test Results

### Protease (LOML-F6-Multisoil Monitor) Delta E Values

| Builder | Start (day 0) | Day 28 |
|---|---|---|
| Without builder | 132.2 | 84.6 |
| 1% EDDS | 141.0 | 129.3 |
| 2% EDDS | 142.0 | 140.2 |
| 1% GLDA | 132.6 | 67.9 |
| 2% GLDA | 142.7 | 83.1 |

Polyphosphonate controls

| | | |
|---|---|---|
| 0.5% HEDP | 134.7 | 63.7 |
| 1% HEDP | 132.2 | 58.3 |
| 0.5% DTPMP | 147.8 | 128.8 |
| 1% DTPMP | 144.9 | 131.3 |

The error of the measurement is +/−2 delta E units. Therefore, any value >2 (sum delta E) means that EDDS (in the context of the tested composition) exhibits a directional and visible contribution to the overall stability of the respective detergent formulation. Any value >4 (sum delta E) means that the EDDS (in the context of the tested composition) exhibits even a significant contribution to the overall stability of the used enzyme.

1. A liquid cleaning composition comprising
(i) ethylenediamine-N,N′-disuccinic acid (EDDS) in an amount ranging from 0.0005% to 20% by weight of the composition;
(ii) at least one enzyme in an amount ranging from 0.000001% to 5% by weight of the composition, wherein the at least one enzyme is selected from the group consisting of amylase and protease;
(iii) at least one anionic surfactant in an amount ranging from 0.1% to 50% by weight of the composition;
(iv) calcium (Ca²⁺) in an amount ranging from 0.000001% to 5% by weight of the composition; and
(v) water,
wherein the cleaning composition has a viscosity ranging from 20 to 10000 mPa*s and a pH-value ranging between 4 and 14.

2. The liquid cleaning composition according to claim 1, wherein ethylenediamine-N,N′-disuccinic acid (EDDS) is present in an amount ranging from 0.001% to 15% by weight of the composition.

3. The liquid cleaning composition according to claim 1, wherein the at least enzyme is present in an amount ranging from 0.00001% to 2% by weight of the composition.

4. The liquid cleaning composition according to claim 1, wherein
(a) the amylase is an alpha-amylase; and/or
(b) the protease is a subtilisin protease.

5. The liquid cleaning composition according to claim 4, wherein the liquid cleaning composition further comprises a protease stabilizing system comprising a peptide aldehyde.

6. The liquid cleaning composition according to claim 1, wherein the at least one anionic surfactant
(a) is present in an amount ranging from 2% to 40% by weight of the composition; and/or
(b) is selected from the group consisting of linear alkylbenzenesulfonates (LAS), alkyl sulfates (AS), alkyl alkoxy sulfates (AES), alkyl alkoxy carboxylates, modified alkylbenzene sulfonate (MLAS), methyl ester sulfonate (MES), alkyl sulfosuccinates and alpha-olefin sulfonate (AOS).

7. The liquid cleaning composition according to claim 1, wherein calcium (Ca²⁺) is present in an amount ranging from 0.0001% to 3% by weight of the composition.

8. The liquid cleaning composition according to claim 1, wherein the viscosity ranges from 30 to 3000 mPa*s.

9. The liquid cleaning composition according to claim 1, wherein a pH-value ranges from 5 to 12.

10. The liquid cleaning composition according to claim 1, wherein the cleaning composition is a detergent composition.

11. The liquid cleaning composition according to claim 1, wherein the cleaning composition further comprises at least one element selected from the group consisting of nonanionic surfactants, amphoteric surfactants, co-builders, alcohols, biocides, thickeners, water soluble polymers, clay soil removal/anti-redeposition agents, polymeric soil release agents, bleaching agents, bleach activators, brighteners, malodor control agents, pigments, dyes, opacifiers, hueing agents, dye transfer inhibiting agents, suds suppressors (antifoams), anti-corrosion agents, softeners and perfumes.

12. A method of using the liquid cleaning composition according to a m claim 1, the method comprising using the liquid cleaning composition for cleaning of fabrics.

13. A cleaning method comprising contacting the liquid cleaning composition according to claim 1 and fabrics.

14. A method of manufacturing a liquid cleaning composition comprising bringing in contact the components (i) to (v) of claim 1 and mixing them the components.

15. The liquid cleaning composition according to claim 1, wherein ethylenediamine-N,N′-disuccinic acid (EDDS) is present in an amount ranging from to 0.01% to 10% by weight of the composition.

16. The liquid cleaning composition according to claim 1, wherein the at least one enzyme is present in an amount ranging from 0.0001% to 1% by weight of the composition.

17. The liquid cleaning composition according to claim 1, wherein the at least one anionic surfactant is present in an amount ranging from 3% to 30% by weight of the composition.

18. The liquid cleaning composition according to claim 1, wherein calcium (Ca²⁺) is present in an amount ranging from 0.0010% to 1T % by weight of the composition.

19. The liquid cleaning composition according to claim 1, wherein the viscosity ranges from 40 to 2500 mPa*s.

20. The liquid cleaning composition according to claim 1, wherein a pH-value ranges from 6 to 10.
